(19) United States
(12) Patent Application Publication
(10) Pub. No.: US 2007/0284558 A1
(43) Pub. Date: Dec. 13, 2007

(54) FIRE INSULATING BARRIER MATERIAL FOR A FIREFIGHTER PROTECTIVE GARMENT

(76) Inventors: Paul R. Flay, Cowansville (CA); Michel Hebert, Granby (CA); Louis Bibeau, Beaconsfield (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/610,721

(22) Filed: Dec. 14, 2006

Related U.S. Application Data
(63) Continuation of application No. PCT/CA05/00918, filed on Jun. 14, 2004.
(60) Provisional application No. 60/578,865, filed on Jun. 14, 2004.

(51) Int. Cl. C09K 21/00

(52) U.S. Cl. 252/608

(57) ABSTRACT

The fire insulating barrier material (10) is for use in a firefighter's protective garment. It material comprises a first fabric layer (12) and a second fabric layer (14) attached to the first layer (12) by pile yarns (16), thereby creating a space (18) therebetween. The space (18) contains an insulating substance. This material (10) advantageously uses a simpler confection and a more compact arrangement than conventional fire insulating barrier materials.

### CROSS-REFERENCE TO RELATED APPLICATIONS

This application is a continuation of International Patent Application No. PCT/CA2005/000918 filed on Jun. 14, 2005 designating the United States of America, which PCT Application claims benefit of U.S. Provisional Patent Application No. 60/578,865 filed on Jun. 14, 2004, all of which are herein incorporated by reference.

### BACKGROUND

This invention relates to a fire insulating barrier material for use as a thermal barrier in a firefighter's protective garment.

The materials that currently exist for the preparation of fire insulating barriers generally comprise a multitude of layers, which make these materials complicated to assemble together. Conventional firefighter's protective garments are generally made using at least three distinct layers. The first layer is the outer shell which provides protection against fire, thermal flash hazards, mechanical constraints and other factors involved in fighting fires. The second layer is the moisture barrier that ensures comfort through the waterproof/breathability concept obtained by means of specific hydrophilic/hydrophobic membranes associated with a textile. The third layer is the thermal liner, which provides the most thermal insulation by entrapping air in a traditional thick needle punched batt slowing down heat transmission. To improve the durability of this layer, a woven facecloth fabric is quilted on it.

Keeping in mind that a compromise is required between adequate heat insulation and lightest possible weight, the combination of these three conventional layers defines the performance characteristics of the entire composite system. However, the known composite assemblies tend to be heavy and expensive to produce.

It would be therefore highly desirable to be provided with a fire insulating barrier material of a simpler confection and compact arrangement.

### SUMMARY

One aspect of the present invention is to provide a fire insulating barrier for a firefighter's protective garment comprising a first fire-resistant fabric layer and a second fire-resistant fabric layer attached to the first layer by pile yarns, thereby creating a space therebetween, the space containing an insulating substance. The fabric layers are intended to be either woven fabric or knitted fabric and the insulating substance can be selected from, but not limited to air, aerogel phase change materials, or a combination thereof.

In accordance with another aspect of the present invention, the fabric can be selected from the group consisting of aramid, polyacrylate, phenolic, polybenzimidazole, polyacrylonitrile oxide, polybenzoxazole, melamine and a combination thereof. The aramid can be selected from, but not limited to, polyaraphenylene terephtalamide, such as KEVLAR™, polymetaphenylene isophtalamide, such as NOMEX™, polyparaphenylene terephtalamide copolymer, such as TECHNORA™, polyamide imide such as KERMEL™, copolyimide such as P84™, or a combination thereof. The polyacrylate can be, without limitation, INIDEX™, the phenolic can be, without limitation, KYNOL™, The polybenzimidazole can be, without limitation, PBI™. The polyacrylonitrile oxide can be, without limitation, SIGRAFIL™. The melamine can be, without limitation, BASOFIL™. The polybenzoxazole can be, without limitation, ZYLON™.

In accordance with a further aspect of the invention, the material can have a thickness varying from 1 to 8 mm, more preferably from 2 to 3 mm.

In accordance with a further aspect of the invention, the material can be covered with a polymer, such as, but not limited to, polyurethane, polyether, polyester, polytetrafluoroethylene, polyolefin, polyethylene, polypropylene or a combination thereof. The polymer can be in a form of membrane typically laminated on the material, in the form of a coating or a combination thereof. More preferably, the material has an E-PTFE membrane laminated thereto.

In accordance with a further aspect of the invention, the thermal barrier can comprise the fire insulating barrier material of the present invention and an outer shell. Preferably, the outer shell is fire resistant and/or waterproof.

### BRIEF DESCRIPTION OF THE FIGURES

The invention is illustrated but is not restricted by the appended figures in which:

FIG. 1 is a cross-sectional view of a possible embodiment of the fire insulating barrier material;

FIG. 2 is a cross-sectional view of another possible embodiment of the fire insulating barrier material; and

FIG. 3 is a cross-sectional view showing an example of a thermal barrier made of the fire insulating material of FIG. 2 with an outer shell.

### DETAILED DESCRIPTION

The present invention is concerned with a fire insulating barrier material (10) used in protective garment for firefighters. This material (10) is designed to be at least in compliance with the standard from the National Fire Protection Association (NFPA) known as NFPA 1971, or any equivalent thereof.

The material (10) comprises a first fire-resistant layer of fabric (12) and a second fire-resistant layer of fabric (14), which can be either woven or knitted. This fabric forming the layers (12, 14) is preferably made of aramid, polyacrylate, phenolic, polybenzimidazole, polyacrylonitrile oxide, polybenzoxazole, melamine or a combination thereof. The aramid can be selected from, but not limited to, polyaraphenylene terephtalamide, such as KEVLAR™, polymetaphenylene isophtalamide, such as NOMEX™, polyparaphenylene terephtalamide copolymer, such as TECHNORA™, polyamide imide such as KERMEL™ and copolyimide such as P84™. The polyacrylate can be, without limitation, INIDEX™, the phenolic can be, without limitation, KYNOL™. The polybenzimidazole can be, without limitation, PBI™. The polyacrylonitrile oxide can be, without limitation, SIGRAFIL™. The melamine can be, without limitation, BASOFIL™. The polybenzoxazole can be, without limitation, ZYLON .

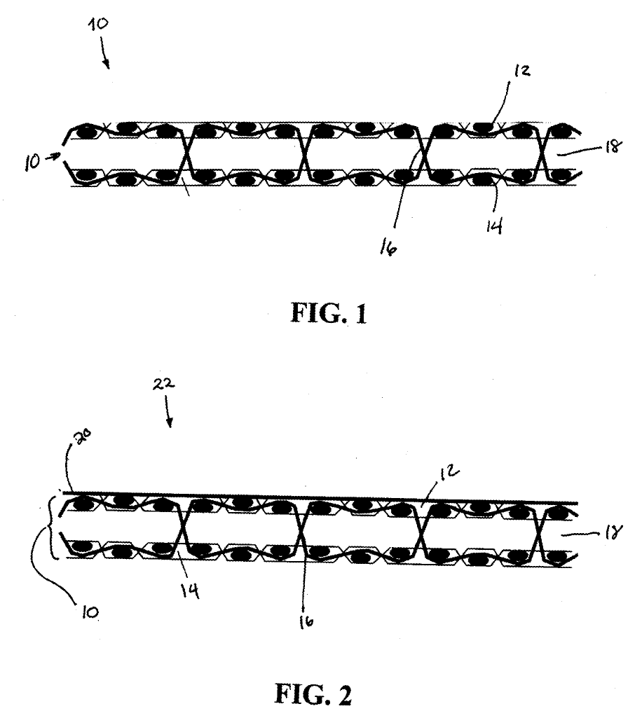

In FIG. 1, the two layers (12, 14) of fabric are held together by a pile yarn (16) in such a way as to create a space (18) between the layers (12, 14). The layers (12, 14) can be made of the same material or of different materials. The space (18) contains an insulating substance such as, but not limited to, air, phase change materials (PCM) or aerogels. The expression “phase change material” is intended to mean a material used to store heat by melting. One of the advantages of the material (10) is that it can retain more insulating substance than the conventional needle punched batt of the same thickness.

In FIG. 2, the material (10) is provided with a waterproof, breathing membrane (20). The material (10) then forms a thermal barrier (22) with the membrane (22). The membrane (20) is non-flammable and can be an e-PTFE membrane directly laminated on the material (10) or can consists in a coating, such as a silicon coating having PCM encapsulated into.

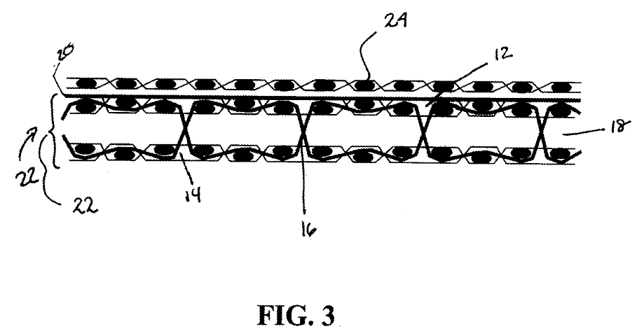

The thermal barrier (22) can be provided with an outer shell (24) for further protection against direct exposure to flames, heat, abrasion, etc, as shown in FIG. 3. The outer shell (24) is preferably made of fire resistant and/or waterproof material. U.S. Pat. Nos. 4,188,445; 4,255,817; 4,937,136; 5,007,112; 5,014,357; 5,050,241 and 5,136,723 disclose examples of outer shells that are suitable for fire-resistant garments.

When the material (10) of the present invention is used in a firefighter's protective garment, whether or not laminated with the membrane (20) or with the coating, and whether or not provided with the outer shell (24), it increases comfort while reducing the weight of the garment and still provide a good resistance to heat, flames and other hazards related to firefighting. It is particularly suitable for use in the confection of a bunker suit.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A fire insulating barrier material for a firefighter's protective garment, wherein the material comprises a first fire-resistant fabric layer and a second fire-resistant fabric layer attached to the first layer by pile yarns, thereby creating a space therebetween, the space containing an insulating substance.

2. The material of claim 1, wherein the first and second layer are woven fabric.

3. The material of claim 1, wherein the first and second layer are knitted fabric.

4. The material of claim 1, wherein the insulating substance is selected from the group consisting of air, aerogel, phase change materials and a combinations thereof.

5. The material of claim 1, wherein the insulating substance is air.

6. The material of claim 1, wherein at least one of the layers is made of a material selected from the group consisting of aramid, polyacrylate, phenolic, polybenzimidazole, polyacrylonitrile oxide, polybenzoxazole, melamine and a combination thereof.

7. The material of claim 6, wherein the aramid is selected from the group consisting of polyaraphenylene terephtalamide, polymetaphenylene isophtalamide, polyparaphenylene terephtalamide copolymer, polyamide imide, copolyimide and a combination thereof.

8. The material of claim 7, wherein the polyparaphenylene terephtalamide is KEVLAR™.

9. The material of claim 7, wherein the polymetaphenylene isophtalamide is NOMEX™.

10. The material of claim 7, wherein the polyparaphenylene terephtalamide copolymer is TECHNORA™.

11. The material of claim 7, wherein the polyamide imide is KERMEL™.

12. The material of claim 7, wherein the copolyimide is P84™.

13. The material of claim 6, wherein the polyacrylate is INIDEX™.

14. The material of claim 6, wherein the phenolic is KYNOL™.

15. The material of claim 6, wherein the polybenzimidazole is PBI™.

16. The material of claim 6, wherein the polyacrylonitrile oxide is SIGRAFIL™.

17. The material of claim 6, wherein the melamine is BASOFIL™.

18. The material of claim 6, wherein the polybenzoxazole is ZYLON™.

19. The material of claim 1, wherein the material has a thickness varying from 1 to 8 mm.

20. The material of claim 1, wherein the material has a thickness varying from 2 to 3 mm.

21. The material of claim 1, wherein at least one of the first and the second layer is covered with a polymer on at least one side thereof.

22. The material of claim 21, wherein the polymer is selected from the group consisting of polyurethane, polyether, polyester, polytetrafluoroethylene, polyolefin, polyethylene, polypropylene and a combination thereof.

23. The material of claim 22, wherein the polymer is in a form of a membrane, a coating or a combination thereof.

24. The material of claim 23, wherein the membrane is laminated on at least one of the first and the second layer.

25. The material of claim 23, wherein the polymer is an E-PTFE membrane laminated on the first or second layer.

26. The material of claim 1, wherein the material is covered with an outer shell.

27. The material of claim 26, wherein the outer shell is waterproof.

28. Use of the thermal barrier material of claim 1 for the confection of a bunker suit.
